(19) United States
(12) Patent Application Publication
(10) Pub. No.: US 2005/0275491 A1
(43) Pub. Date: Dec. 15, 2005

(54) REMOTE CONTROL CIRCUIT BREAKER

(76) Inventor: JOHN C DIPIERO Jr., HEMLOCK, MI (US)

Correspondence Address: JOHN C DIPIERO JR, 397 SANDRIDGE DRIVE, HEMLOCK, MI, 48626, US

(21) Appl. No.: 10/710,056

(22) Filed: Jun. 15, 2004

(51) Int. Cl. H01H 83/00

(52) U.S. Cl. 335/20

(57) ABSTRACT

Remote Circuit Breaker is a simple application allowing the user to trip or activate the breaker from a distance, rather than at the breaker box.

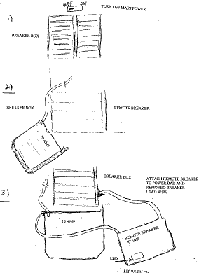

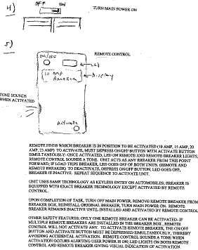

The remote circuit breaker attaches to the circuit breaker box in place of the original circuit breaker. The remote breaker will not activate until turned on by the remote control. Once activated, the remote breaker acts as any circuit breaker; if the load trips the breaker, the remote breaker inactivates. The remote control allows the user to activate/inactivate the breaker from the job cite rather than having to physically switch the breaker on and off at the breaker box.

The remote breaker has the same technology as the original breaker, except for the activation which is done by remote control. The remote control will sound a tone when activated, and a led will light, a led will also light on the remote breaker. Once the breaker is off, it will remain off until reactivated only by the remote control unit.

Upon completion of the task, the main power should be turned off, the remote breaker removed, the original breaker replaced, and the main power turned on. Remote breakers will come in 5, 10, 15, 20, 25, and 30 amp configurations; the remote used should equal the original breaker amperage.

1. Remote Circuit Breaker will reduce repair time by allowing the user to activate/inactivate the breaker from the job site, rather than repeated trips to the breaker box.
